(19) United States
(12) Patent Application Publication
(10) Pub. No.: US 2026/0059609 A1
(43) Pub. Date: Feb. 26, 2026

(54) CELL RE-SELECTION TRANSITION PERIODS FOR CELL DETECTION

(71) Applicant: QUALCOMM Incorporated, San Diego, CA (US)

(72) Inventors: Prashant SHARMA, San Marcos, CA (US); Ruiming ZHENG, Beijing (CN); Muhammad Nazmul ISLAM, Littleton, MA (US)

(21) Appl. No.: 19/474,467

(22) PCT Filed: May 15, 2023
(86) PCT No.: PCT/CN2023/094126

§ 371 Date: Oct. 10, 2025

(51) Int. Cl. H04W 76/28

(52) U.S. Cl. CPC H04W 76/28

(57) ABSTRACT

Various aspects of the present disclosure generally relate to wireless communication. In some aspects, a user equipment (UE) may receive, from a network node, configuration information indicating a first discontinuous reception (DRX) cycle configuration associated with a first cell and a second DRX cycle configuration associated with a second cell. The UE may initiate, while a selected cell of the UE is the first cell, a cell detection procedure associated with a neighbor cell. The UE may switch, prior to a completion of the cell detection procedure, the selected cell from the first cell to the second cell. The UE may perform, during a cell re-selection transition period, one or more measurements of the neighbor cell associated with the cell detection procedure, having an amount of time that is associated with the first DRX cycle configuration and/or the second DRX cycle configuration. Numerous other aspects are described.

### FIELD OF THE DISCLOSURE

Aspects of the present disclosure generally relate to wireless communication and to techniques and apparatuses for cell re-selection transition periods for cell detection.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories and one or more processors coupled to the one or more memories. The one or more processors may be configured to cause the UE to receive, from a network node, configuration information indicating a first discontinuous reception (DRX) cycle configuration associated with a first cell and a second DRX cycle configuration associated with a second cell. The one or more processors may be configured to cause the UE to initiate, while a selected cell of the UE is the first cell, a cell detection procedure associated with a neighbor cell. The one or more processors may be configured to switch, prior to a completion of the cell detection procedure, the selected cell from the first cell to the second cell. The one or more processors may be configured to cause the UE to perform, during a cell re-selection transition period, one or more measurements of the neighbor cell associated with the cell detection procedure, the cell re-selection transition period having an amount of time that is associated with at least one of the first DRX cycle configuration or the second DRX cycle configuration.

Some aspects described herein relate to a network node for wireless communication. The network node may include one or more memories and one or more processors coupled to the one or more memories. The one or more processors may be configured to cause the network node to receive a capability report, associated with a UE, indicating one or more supported parameters for calculating an amount of time associated with a cell detection during a cell re-selection transition period. The one or more processors may be configured to cause the network node to transmit an indication, for the UE, of one or more parameters for calculating the amount of time associated with the cell detection during the cell re-selection transition period in accordance with the capability report.

Some aspects described herein relate to a method of wireless communication performed by a UE. The method may include receiving, from a network node, configuration information indicating a first DRX cycle configuration associated with a first cell and a second DRX cycle configuration associated with a second cell. The method may include initiating, while a selected cell of the UE is the first cell, a cell detection procedure associated with a neighbor cell. The method may include switching, prior to a completion of the cell detection procedure, the selected cell from the first cell to the second cell. The method may include performing, during a cell re-selection transition period, one or more measurements of the neighbor cell associated with the cell detection procedure, the cell re-selection transition period having an amount of time that is associated with at least one of the first DRX cycle configuration or the second DRX cycle configuration.

Some aspects described herein relate to a method of wireless communication performed by a network node. The method may include receiving a capability report, associated with a UE, indicating one or more supported parameters for calculating an amount of time associated with a cell detection during a cell re-selection transition period. The method may include transmitting an indication, for the UE, of one or more parameters for calculating the amount of time associated with the cell detection during the cell re-selection transition period in accordance with the capability report.

Some aspects described herein relate to a non-transitory computer-readable medium that stores a set of instructions for wireless communication by a UE. The set of instructions, when executed by one or more processors of the UE, may cause the UE to receive, from a network node, configuration information indicating a first DRX cycle configuration associated with a first cell and a second DRX cycle configuration associated with a second cell. The set of instructions, when executed by one or more processors of the UE, may cause the UE to initiate, while a selected cell of the UE is the first cell, a cell detection procedure associated with a neighbor cell. The set of instructions, when executed by one or more processors of the UE, may cause the UE to switch, prior to a completion of the cell detection procedure, the selected cell from the first cell to the second cell. The set of instructions, when executed by one or more processors of the UE, may cause the UE to perform, during a cell re-selection transition period, one or more measurements of the neighbor cell associated with the cell detection procedure, the cell re-selection transition period having an amount of time that is associated with at least one of the first DRX cycle configuration or the second DRX cycle configuration.

Some aspects described herein relate to a non-transitory computer-readable medium that stores a set of instructions for wireless communication by a network node. The set of instructions, when executed by one or more processors of the network node, may cause the network node to receive a capability report, associated with a UE, indicating one or more supported parameters for calculating an amount of time associated with a cell detection during a cell re-selection transition period. The set of instructions, when executed by one or more processors of the network node, may cause the network node to transmit an indication, for the UE, of one or more parameters for calculating the amount of time associated with the cell detection during the cell re-selection transition period in accordance with the capability report.

Some aspects described herein relate to an apparatus for wireless communication. The apparatus may include means for receiving, from a network node, configuration information indicating a first DRX cycle configuration associated with a first cell and a second DRX cycle configuration associated with a second cell. The apparatus may include means for initiating, while a selected cell of the apparatus is the first cell, a cell detection procedure associated with a neighbor cell. The apparatus may include means for switching, prior to a completion of the cell detection procedure, the selected cell from the first cell to the second cell. The apparatus may include means for performing, during a cell re-selection transition period, one or more measurements of the neighbor cell associated with the cell detection procedure, the cell re-selection transition period having an amount of time that is associated with at least one of the first DRX cycle configuration or the second DRX cycle configuration.

Some aspects described herein relate to an apparatus for wireless communication. The apparatus may include means for receiving a capability report, associated with a UE, indicating one or more supported parameters for calculating an amount of time associated with a cell detection during a cell re-selection transition period. The apparatus may include means for transmitting an indication, for the UE, of one or more parameters for calculating the amount of time associated with the cell detection during the cell re-selection transition period in accordance with the capability report.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 illustrates an example of a wireless network in which a UE may support additional communication modes, in accordance with the present disclosure.

FIG. 5 is a diagram illustrating an example of a discontinuous reception (DRX) configuration, in accordance with the present disclosure.

FIG. 6 is a diagram of an example associated with operations for cell re-selection transition periods for cell detection, in accordance with the present disclosure.

FIG. 7 is a diagram of an example associated with cell re-selection transition periods for cell detection, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

A user equipment (UE) may perform cell measurements and evaluate cell re-selection criteria during a single paging time window (PTW). However, neighbor cell detections may occur across multiple PTWs. For example, a UE may collect one or more samples (e.g., measurements of a reference signal, such as a synchronization signal block (SSB)) associated with a neighbor cell during a cell detection procedure. The UE may need to collect a certain quantity of samples to complete the cell detection procedure. When the UE re-selects to a new cell, the UE may receive a new list of neighbor cells to be monitored. One or more cells in the new list of neighbor cells may have been in the process of detection when the UE performed the cell re-selection. For example, when camping on a first cell in a radio resource control (RRC) inactive mode, the UE may initiate a cell detection procedure for a neighbor cell. Prior to completing the cell detection procedure, the UE may re-select to a new cell (e.g., a second cell). The UE may camp on the second cell in the RRC inactive mode. The neighbor cell may be included in the list of neighbor cells to be monitored when the UE is camping on the second cell.

However, the first cell and the second cell may be associated with different discontinuous reception (DRX) cycle configurations and/or may support different types of DRX cycle configurations. For example, the first cell may support an enhanced extended DRX (eDRX) cycle configuration (e.g., a Release 18 enhanced eDRX cycle configuration) and the second cell may not support eDRX. As another example, the first cell may support the enhanced eDRX cycle configuration and the second cell may only support the non-enhanced eDRX cycle configuration (e.g., may only support a Release 17 eDRX and not the Release 18 eDRX). As another example, the first cell and the second cell may both support the enhanced eDRX cycle configuration, but configuration parameters may be different for the first cell and the second cell (e.g., eDRX cycle durations may be different, PTW configurations may be different, or other configuration parameters may be different). As described elsewhere herein, an allowable (or expected) amount of time associated with performing a cell detection procedure (e.g., a delay condition for performing cell detection of neighbor cells) may be defined in terms of a DRX cycle. Therefore, when the UE re-selects to the second cell, the amount of time associated with the delay condition for performing cell detection of the neighbor cell (e.g., that is in the process of detection when the UE switches the selected cell from the first cell to the second cell) is unclear. The UE may not know how much time is expected to be associated with completing the cell detection procedure for the neighbor cell. As a result, the network (e.g., a network node) and the UE may not be synchronized as to the operations of the UE. As another example, the UE may consume resources (e.g., time resources, power resources, or other resources) performing the cell detection procedure over an incorrect amount of time. As another example, the network may incorrectly assume that the UE has detected a neighbor cell after a given amount of time because the UE and the network are not synchronized as to the delay condition for cell detection of the neighbor cell.

Various aspects relate generally to cell re-selection transition periods for cell detection of neighbor cells. Some aspects more specifically relate to calculating a neighbor cell detection delay during a cell re-selection transition period when a UE performs a cell re-selection from one cell to another cell having different DRX cycle (or eDRX cycle) configuration (e.g., while the cell detection procedure is ongoing). In some aspects, a time period (e.g., a cell re-selection transition period) may be defined for completing cell detection of a neighbor cell when the cell detection is in progress when a cell re-selection occurs. For example, the cell re-selection transition period may be an amount of time from when the UE initiates the cell detection procedure for a neighbor cell while camping on a first cell until the UE completes the cell detection, measurement, and cell-selection criteria evaluation for the neighbor cell, which completes after the UE has performed cell-reselection from the first cell to the second cell.

The UE may apply or use the cell re-selection transition period when a cell detection procedure for a neighbor cell is in progress when the UE performs reselection from a first cell to a second cell (and is to be completed after switching the selected cell to the second cell) and when one or more DRX (or eDRX) conditions are met. The one or more DRX (or eDRX) conditions may include the first cell and the second cell having different DRX cycle configurations (e.g., different eDRX cycle configurations). In some aspects, the one or more DRX (or eDRX) conditions may include one cell (from the first cell and the second cell) supporting an enhanced eDRX cycle configuration and the other cell (from the first cell and the second cell) not supporting the enhanced eDRX cycle configuration. In some aspects, the one or more DRX (or eDRX) conditions may include the first cell and the second cell having different configuration parameters for the enhanced eDRX cycle configuration.

In some aspects, an amount of time associated with the cell re-selection transition period may be defined based on, or otherwise associated with, a DRX cycle configuration of the first cell and/or a DRX cycle configuration of the second cell. In some aspects, the amount of time associated with the cell re-selection transition period may be defined based on, or otherwise associated with, an amount of time for which the UE has performed the cell detection procedure while camping on the first cell. For example, the amount of time associated with the cell re-selection transition period may be defined based on, or otherwise associated with, a first amount of time associated with performing one or more measurements of the neighbor cell while the selected cell is the first cell, and a second amount of time associated with restarting and performing the cell detection procedure in accordance with the second DRX cycle configuration of the second cell. As another example, the amount of time associated with the cell re-selection transition period may be defined based on, or otherwise associated with, a greater amount of time of a first amount of time associated with performing the cell detection procedure in accordance with the first DRX cycle configuration, or a second amount of time associated with performing the cell detection procedure in accordance with the second DRX cycle configuration. As another example, the amount of time associated with the cell re-selection transition period may be defined based on, or otherwise associated with, a first amount of time associated with performing one or more measurements of the neighbor cell while the selected cell is the first cell, and a second amount of time associated with performing a remaining one or more measurements associated with completing the cell detection procedure in accordance with the second DRX cycle configuration.

Particular aspects of the subject matter described in this disclosure can be implemented to realize one or more of the following potential advantages. In some examples, by defining how to calculate the neighbor cell detection delay in such scenarios, the described techniques can be used to enable the UE to complete cell detections of neighbor cells within an expected amount of time (e.g., expected by the network) when the UE re-selects to a new cell during the performance of the cell detection. This may improve network performance by ensuring that the UE performs the cell detection procedure within the expected amount of time and ensuring that the expected amount of time is synchronized between the UE and the network.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

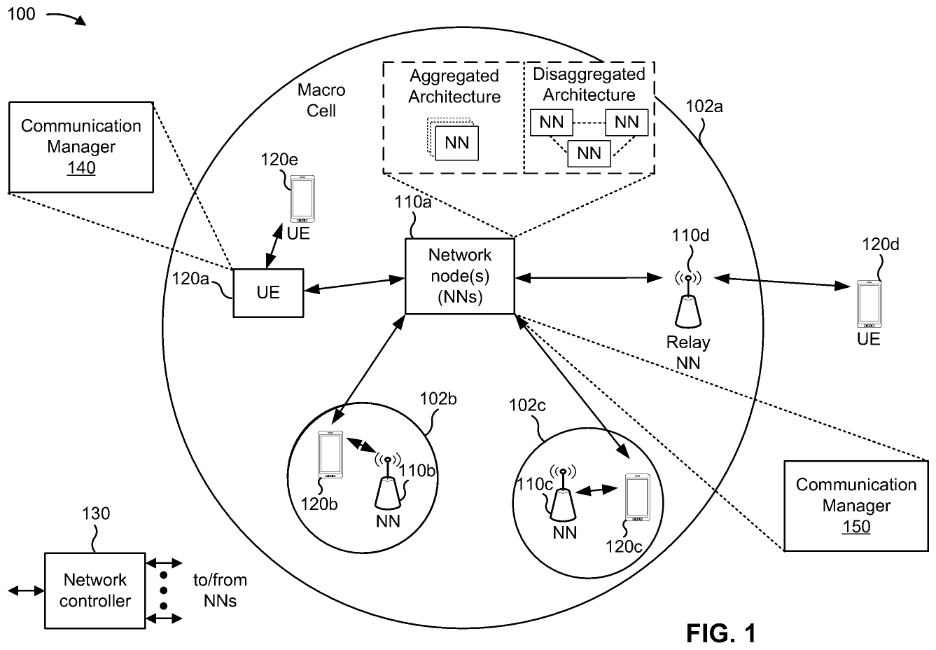

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs (or further enhanced eMTC (feMTC), or enhanced feMTC (efeMTC), or further evolutions thereof, all of which may be simply referred to as “MTC”). An MTC UE may be, may include, or may be included in or coupled with a robot, an unmanned aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless network 100).

Some UEs 120 may be classified according to different categories in association with different complexities and/or different capabilities. UEs 120 in a first category may facilitate massive IoT in the wireless network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, a UE 120 in the third category (a RedCap UE) may support lower latency communication than a UE 120 in the first category (an NB-IoT UE or an eMTC UE), and a UE 120 in the second category (a mission-critical IoT UE or a premium UE) may support lower latency communication than the UE 120 in the third category. Additionally or alternatively, in some examples, a UE 120 in the third category (a RedCap UE) may support higher wireless communication throughput than a UE 120 in the first category (an NB-IoT UE or an eMTC UE), and a UE 120 in the second category (a mission-critical IoT UE or a premium UE) may support higher wireless communication throughput than the UE 120 in the third category. Additionally or alternatively, in some examples, a UE 120 in the first category (an NB-IoT UE or an eMTC UE) may support longer battery life than a UE 120 in the third category (a RedCap UE), and the UE 120 in the third category may support longer battery life than a UE 120 in the second category (a mission-critical IoT UE or a premium UE).

In some examples, a UE 120 of the third category (a RedCap UE) may have capabilities that satisfy first device or performance requirements but not second device or performance requirements, while a UE 120 of the second category (a mission-critical IoT UE or a premium UE) may have capabilities that satisfy the second device or performance requirements (and also the first device or performance requirements, in some examples). For example, a UE 120 of the third category may support a lower maximum modulation and coding scheme (MCS) (for example, a modulation scheme such as quadrature phase shift keying (QPSK)) than an MCS supported by a UE 120 of the second category (for example, a modulation scheme such as 256-quadrature amplitude modulation (QAM)). As another example, a UE of the third category may support a lower maximum transmit power than a maximum transmit power of a UE of the second category. As another example, a UE 120 of the third category may have a less advanced beamforming capability than a beamforming capability of a UE 120 of the second category (for example, a RedCap UE may not be capable of forming as many beams as a premium UE). As another example, a UE 120 of the third category may require a longer processing time than a processing time of a UE 120 of the second category. As another example, a UE 120 of the third category may include less hardware or less complex hardware (such as fewer antennas, fewer transmit antennas, and/or fewer receive antennas) than a UE 120 of the second category. As another example, a UE 120 of the third category may not be capable of communicating on as wide of a maximum bandwidth part (BWP) as a UE 120 of the second category.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

In some examples, a UE 120 may implement power saving features, such as for UEs 120 in a radio resource control (RRC) connected mode, an RRC idle mode, or an RRC inactive mode. Power saving features may include, for example, relaxed radio resource monitoring (such as for devices operating in low mobility or in good radio conditions), discontinuous reception (DRX), reduced physical downlink control channel (PDCCH) monitoring during active times, and/or power-efficient paging reception.

A UE 120 may operate in association with a DRX cycle configuration (for example, indicated to the UE 120 by a network node 110). DRX operation may enable the UE 120 to enter a sleep mode at various times while in the coverage area of a network node 110 to reduce power consumption for conserving battery resources, among other examples. The DRX cycle configuration generally configures the UE 120 to operate in association with a DRX cycle. The UE 120 may repeat DRX cycles with a configured periodicity according to the DRX cycle configuration. A DRX cycle may include a DRX on duration during which the UE 120 is in an awake mode or in an active state, and one or more durations during which the UE 120 may operate in an inactive state, which may be opportunities for the UE 120 to enter a DRX sleep mode in which the UE 120 may refrain from monitoring for communications from a network node 110. Additionally or alternatively, the UE 120 may deactivate one or more antennas, RF chains, and/or other hardware components or devices while operating in the DRX sleep mode.

The time during which the UE 120 is configured to be in an active state during a DRX on duration may be referred to as an active time, and the time during which the UE 120 is configured to be in an inactive state, such as during a DRX sleep duration, may be referred to as an inactive time. During a DRX on duration, the UE 120 may monitor for downlink communications from one or more network nodes 110. If the UE 120 does not detect and/or does not successfully decode any downlink communications during the DRX on duration, the UE 120 may enter a DRX sleep mode for the inactive time duration at the end of the DRX on duration. Conversely, if the UE 120 detects and/or successfully decodes a downlink communication during the DRX on duration, the UE 120 may remain in the active state for the duration of a DRX inactivity timer (which may extend the active time). The UE 120 may start the DRX inactivity timer at a time at which the downlink communication is received. The UE 120 may remain in the active state until the DRX inactivity timer expires, at which time the UE 120 may transition to the sleep mode for an inactive time duration. Additionally or alternatively, the UE 120 may use a DRX cycle referred to as an extended DRX (eDRX) cycle, such as for use cases that are tolerant to latency. An eDRX cycle may include a relatively longer inactive time relative to a baseline DRX cycle (for example, an eDRX cycle may have a lower ratio of active time to inactive time).

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node, configuration information indicating a first DRX cycle configuration associated with a first cell and a second DRX cycle configuration associated with a second cell; initiate, while a selected cell of the UE is the first cell, a cell detection procedure associated with a neighbor cell; switch, prior to a completion of the cell detection procedure, the selected cell from the first cell to the second cell; and perform, during a cell re-selection transition period, one or more measurements of the neighbor cell associated with the cell detection procedure, the cell re-selection transition period having an amount of time that is associated with at least one of the first DRX cycle configuration or the second DRX cycle configuration. Additionally, or alternatively, the communication manager 140 may perform one or more other operations described herein.

In some aspects, the network node 110 may include a communication manager 150. As described in more detail elsewhere herein, the communication manager 150 may receive a capability report, associated with a UE, indicating one or more supported parameters for calculating an amount of time associated with a cell detection during a cell re-selection transition period; and transmit an indication, for the UE, of one or more parameters for calculating the amount of time associated with the cell detection during the cell re-selection transition period in accordance with the capability report.

Additionally, or alternatively, the communication manager 150 may perform one or more other operations described herein.

As indicated above, FIG. 1 is provided as an example. Other examples may differ from what is described with regard to FIG. 1.

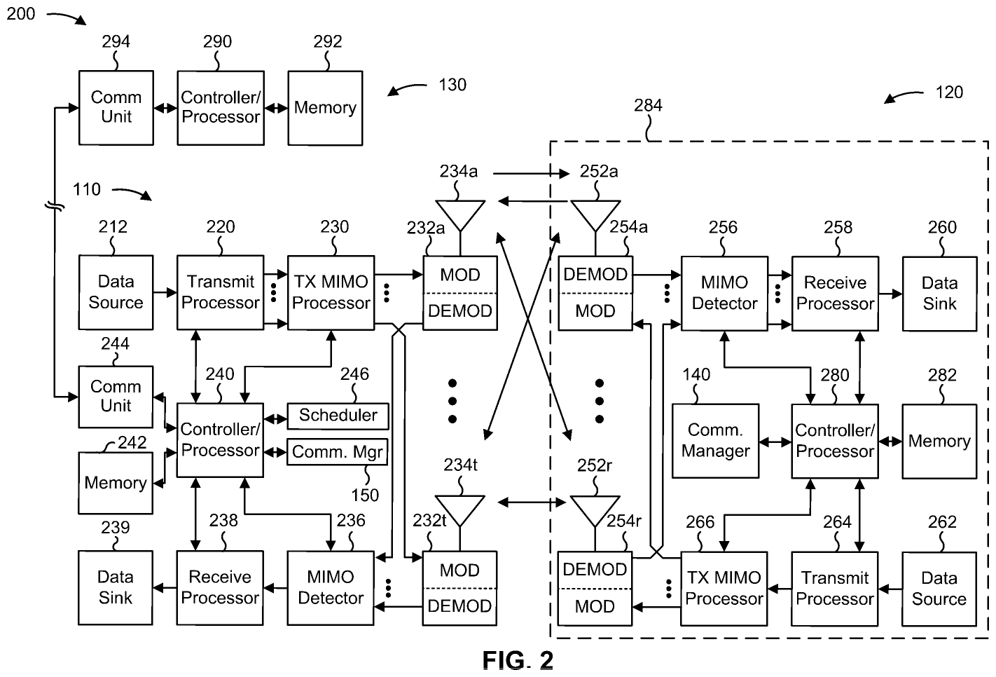

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream.

Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

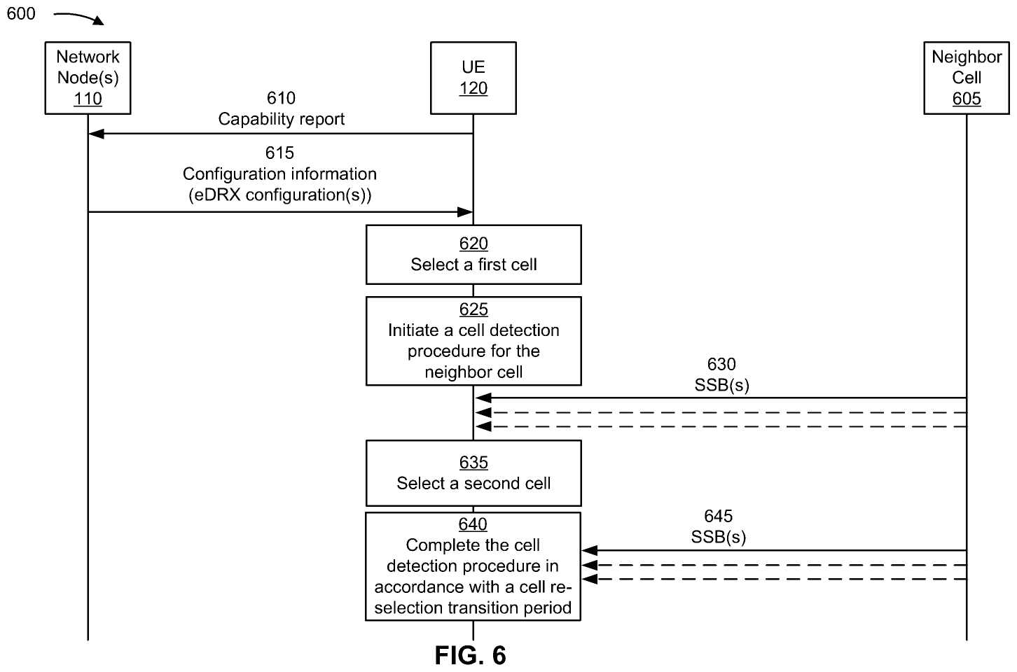

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-11).

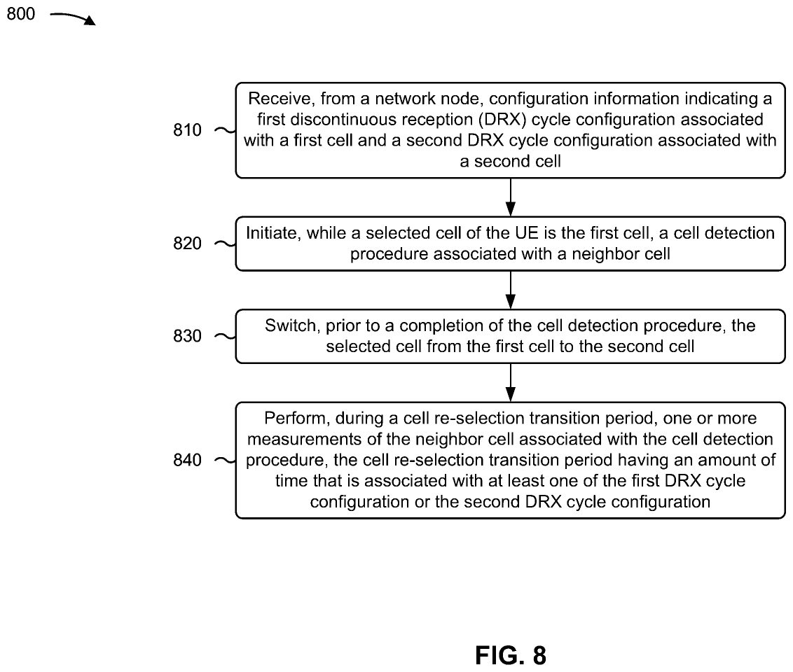

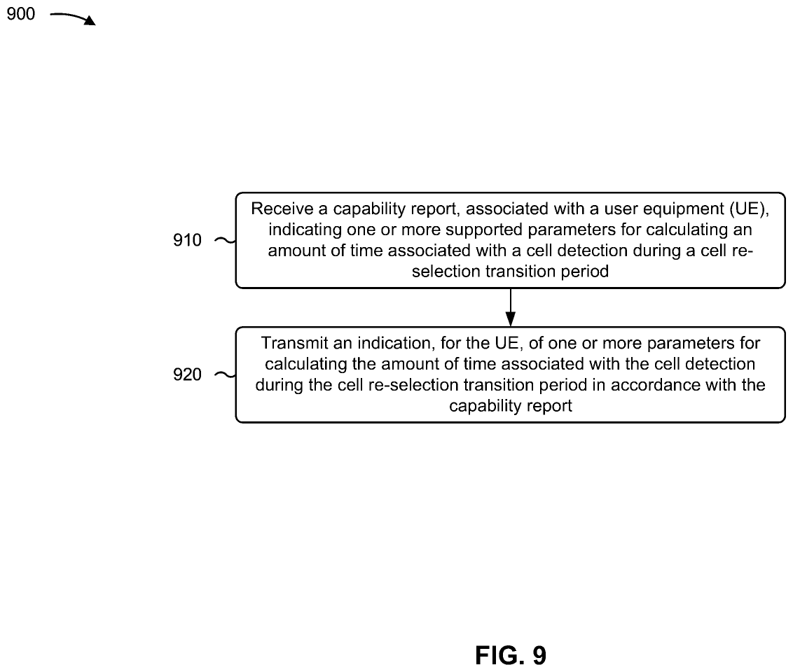

The controller/processor 240 of the network node 110, the controller/processor 280 of the UE 120, and/or any other component(s) of FIG. 2 may perform one or more techniques associated with cell re-selection transition periods for cell detection, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving, from a network node, configuration information indicating a first DRX cycle configuration associated with a first cell and a second DRX cycle configuration associated with a second cell; means for initiating, while a selected cell of the UE is the first cell, a cell detection procedure associated with a neighbor cell; means for switching, prior to a completion of the cell detection procedure, the selected cell from the first cell to the second cell; and/or means for performing, during a cell re-selection transition period, one or more measurements of the neighbor cell associated with the cell detection procedure, the cell re-selection transition period having an amount of time that is associated with at least one of the first DRX cycle configuration or the second DRX cycle configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving a capability report, associated with a UE, indicating one or more supported parameters for calculating an amount of time associated with a cell detection during a cell re-selection transition period; and/or means for transmitting an indication, for the UE, of one or more parameters for calculating the amount of time associated with the cell detection during the cell re-selection transition period in accordance with the capability report. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

As used herein, the network node 110 “outputting” or “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU outputting or transmitting a communication to an RU and the RU transmitting the communication to the UE 120, or may include causing the RU to transmit the communication (e.g., triggering transmission of a physical layer reference signal). Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU. Similarly, the network node 110 “obtaining” a communication may refer to receiving a transmission carrying the communication directly (for example, from the UE 120 to the network node 110) or receiving the communication (or information derived from reception of the communication) via one or more other network nodes or devices.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU).

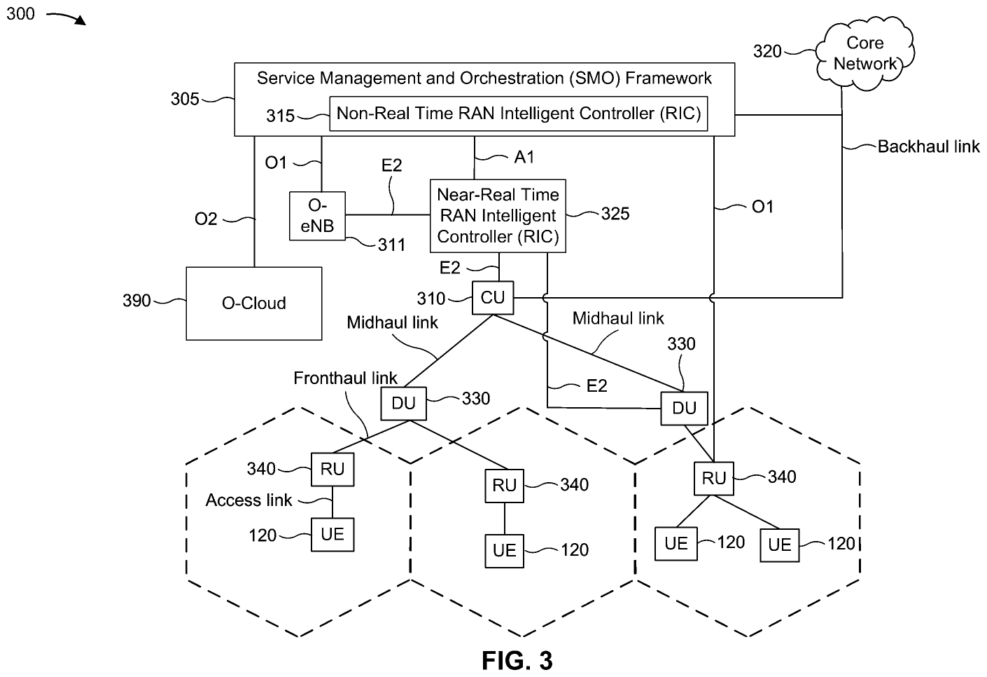

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

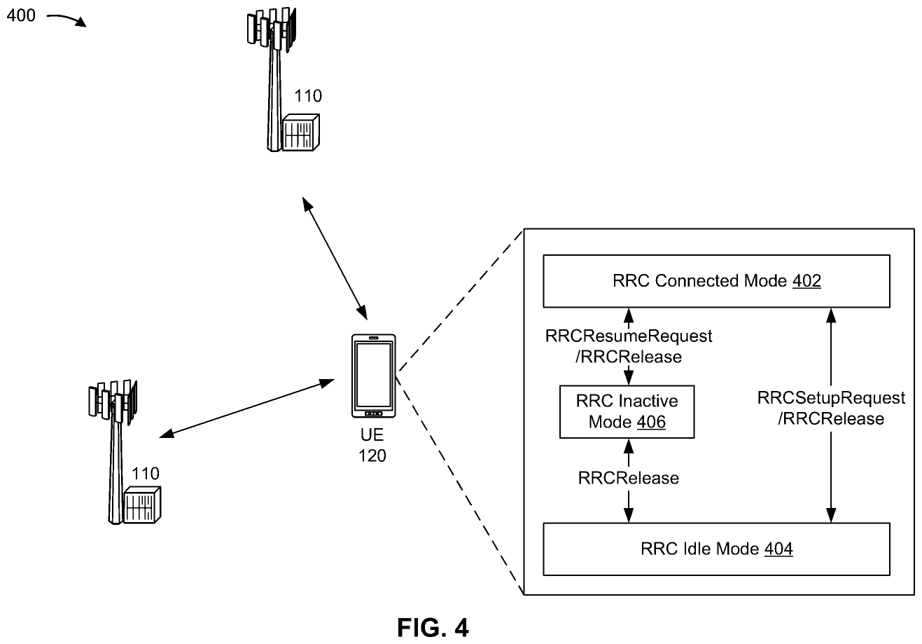

FIG. 4 illustrates an example 400 of a wireless network in which a UE may support additional communication modes, in accordance with the present disclosure.

The UE (e.g., a UE 120) may be communicatively connected with one or more network nodes 110 in the wireless network (e.g., the wireless network 100). For example, the UE may be connected to the one or more network nodes 110 in a dual connectivity configuration. In such examples, a first network node 110 may serve the UE as a primary node and a second network node 110 may serve the UE as a secondary node.

As illustrated in FIG. 4, the UE may support a connected communication mode (e.g., an RRC connected mode 402), an idle communication mode (e.g., an RRC idle mode 404), and an inactive communication mode (e.g., an RRC inactive mode 406).

RRC inactive mode 406 may functionally reside between RRC connected mode 402 and RRC idle mode 404. The RRC connected mode 402 may also be referred to as an RRC active mode.

The UE may transition between different modes based at least in part on various commands and/or communications received from the one or more network nodes 110. For example, the UE may transition from RRC connected mode 402 or RRC inactive mode 406 to RRC idle mode 404 based at least in part on receiving an RRCRelease communication. As another example, the UE may transition from RRC connected mode 402 to RRC inactive mode 406 based at least in part on receiving an RRCRelease with suspendConfig communication. As another example, the UE may transition from RRC idle mode 404 to RRC connected mode 402 based at least in part on receiving an RRCSetupRequest communication. As another example, the UE may transition from RRC inactive mode 406 to RRC connected mode 402 based at least in part on receiving an RRCResumeRequest communication.

When transitioning to RRC inactive mode 406, the UE and/or the one or more network nodes 110 may store a UE context (e.g., an access stratum (AS) context and/or higher-layer configurations). This permits the UE and/or the one or more network nodes 110 to apply the stored UE context when the UE transitions from RRC inactive mode 406 to RRC connected mode 402 in order to resume communications with the one or more network nodes 110, which reduces latency of transitioning to RRC connected mode 402 relative to transitioning to the RRC connected mode 402 from RRC idle mode 404.

In some cases, the UE may communicatively connect with a new master node when transitioning from RRC idle mode 404 or RRC inactive mode 406 to RRC connected mode 402 (e.g., a primary node that is different from the last serving primary node when the UE transitioned to RRC idle mode 404 or RRC inactive mode 406). In this case, the new primary node may be responsible for identifying a secondary node for the UE in the dual connectivity configuration.

In some examples, the UE may perform cell monitoring, cell measurements, and/or cell detection while operating in the RRC inactive mode 406. For example, while operating in the RRC idle mode 404 and/or the RRC inactive mode 406, the UE may perform cell-reselection procedures, such as serving cell measurements and cell re-selection criteria evaluation, and/or intra-frequency, inter-frequency, and/or inter-RAT neighbor cell detection, measurements, and cell-reselection criteria evaluation. In some examples, the cell re-selection procedure(s) may be associated with delays (e.g., an amount of time associated with the UE performing the operations). An allowable amount of time (or an expected amount of time) for the delays may be defined, or otherwise fixed, by a wireless communication standard (such as by 3GPP Technical Specification (T. S.) 38.133 Version 18.1.0) and/or configured by a network node. The allowable amount of time (or an expected amount of time) for the delays may be defined in terms of DRX cycles and/or eDRX cycles. For example, the allowable amount of time (or an expected amount of time) for the delays may be defined in terms of a quantity of DRX cycles (e.g., where a DRX cycle is configured with a given duration).

As indicated above, FIG. 4 is provided as an example. Other examples may differ from what is described with regard to FIG. 4.

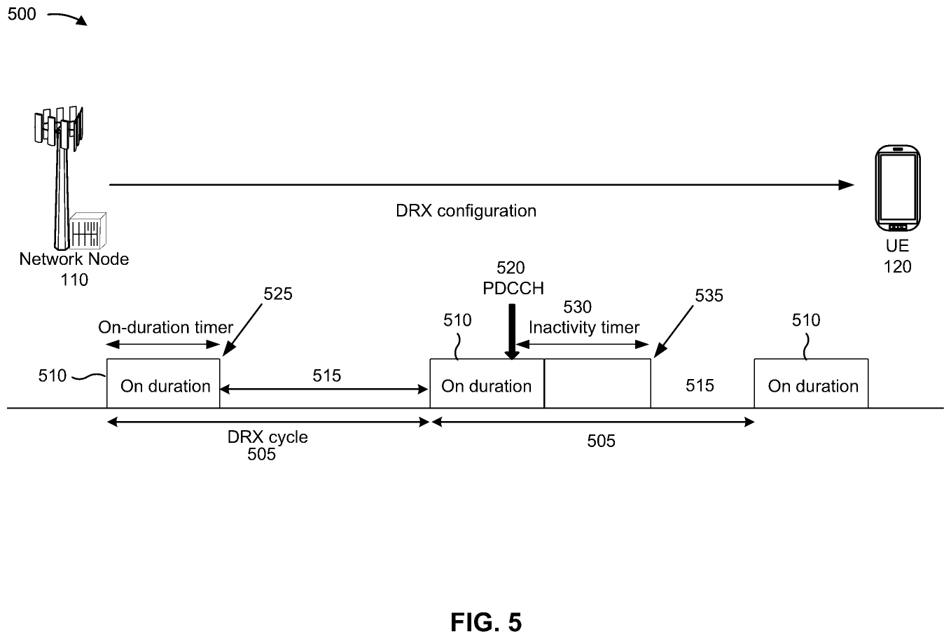

FIG. 5 is a diagram illustrating an example 500 of a discontinuous reception (DRX) configuration, in accordance with the present disclosure.

As shown in FIG. 5, a network node 110 may transmit a DRX cycle configuration to a UE 120 to configure a DRX cycle 505 for the UE 120. A DRX cycle 505 may include a DRX on duration 510 (e.g., during which a UE 120 is awake or in an active state) and an opportunity to enter a DRX sleep state 515. As used herein, the time during which the UE 120 is configured to be in an active state during the DRX on duration 510 may be referred to as an active time, and the time during which the UE 120 is configured to be in the DRX sleep state 515 may be referred to as an inactive time. As described below, the UE 120 may monitor a PDCCH during the active time, and may refrain from monitoring the PDCCH during the inactive time.

During the DRX on duration 510 (e.g., the active time), the UE 120 may monitor a downlink control channel (e.g., a PDCCH), as shown by reference number 520. For example, the UE 120 may monitor the PDCCH for downlink control information (DCI) pertaining to the UE 120. If the UE 120 does not detect and/or successfully decode any PDCCH communications intended for the UE 120 during the DRX on duration 510, then the UE 120 may enter the sleep state 515 (e.g., for the inactive time) at the end of the DRX on duration 510, as shown by reference number 525. In this way, the UE 120 may conserve battery power and reduce power consumption. As shown, the DRX cycle 505 may repeat with a configured periodicity according to the DRX cycle configuration.

If the UE 120 detects and/or successfully decodes a PDCCH communication intended for the UE 120, then the UE 120 may remain in an active state (e.g., awake) for the duration of a DRX inactivity timer 530 (e.g., which may extend the active time). The UE 120 may start the DRX inactivity timer 530 at a time at which the PDCCH communication is received (e.g., in a transmission time interval (TTI) in which the PDCCH communication is received, such as a slot or a subframe). The UE 120 may remain in the active state until the DRX inactivity timer 530 expires, at which time the UE 120 may enter the sleep state 515 (e.g., for the inactive time), as shown by reference number 535. During the duration of the DRX inactivity timer 530, the UE 120 may continue to monitor for PDCCH communications, may obtain a downlink data communication (e.g., on a downlink data channel, such as a physical downlink shared channel (PDSCH)) scheduled by the PDCCH communication, and/or may prepare and/or transmit an uplink communication (e.g., on a physical uplink shared channel (PUSCH)) scheduled by the PDCCH communication. The UE 120 may restart the DRX inactivity timer 530 after each detection of a PDCCH communication for the UE 120 for an initial transmission (e.g., but not for a retransmission). By operating in this manner, the UE 120 may conserve battery power and reduce power consumption by entering the sleep state 515.

In some examples, a DRX cycle may be configured as an eDRX cycle. The eDRX cycle may have a relatively longer duration and/or inactive time (e.g., thereby enabling the UE to be in the inactive mode for longer periods of time, conserving power resources of the UE). For example, for a first version of an eDRX cycle (e.g., as defined, or otherwise fixed, by Release 17 of the 3GPP standard), a UE (e.g., a RedCap UE) may be configured with an eDRX cycle having a duration less than or equal to 10.24 seconds. For a second version (or enhanced version) of an eDRX cycle (e.g., as defined, or otherwise fixed, by Release 18 and/or future releases of the 3GPP standard) a UE (e.g., a RedCap UE) may be configured with an eDRX cycle having a duration greater than 10.24 seconds. The UE may operate using the eDRX only if a cell indicates support for eDRX (e.g., in system information associated with the cell).

As used herein, referring to a “Release” number, such as Release 17 or Release 18, may refer to a Release of the 3GPP standards. For example, the 3GPP uses a system of parallel “Releases” to provide a platform for the implementation of features at a given point in time and then allow for the addition of new functionality in subsequent Releases. For example, a Release N configuration may be a configuration that includes information and/or parameters as defined, or otherwise fixed, by one or more 3GPP Technical Specifications of Release N.

In some examples, a DRX cycle (e.g., an eDRX cycle) may be configured with a paging time window (PTW). The PTW may define a time window during which the UE monitors for paging (e.g., paging occasions may be included within a PTW). For example, an enhanced eDRX cycle may be configured with one or more PTWs. Within a PTW, the UE 120 may perform measurements and/or paging occasion monitoring in accordance with a configured DRX cycle (such as the DRX cycle depicted in FIG. 5). In other examples, an eDRX cycle may not be configured with PTWs. An eDRX cycle configured with a duration greater than 10.24 seconds and/or configured with one or more PTWs may be referred to as an enhanced eDRX cycle or a Release 18 eDRX cycle (e.g., where Release 18 of the 3GPP standards defines information for the configuration of the enhanced eDRX). An eDRX cycle configured with a duration less than or equal to 10.24 seconds and/or configured without PTWs may be referred to as a non-enhanced eDRX cycle or a Release 17 eDRX cycle (e.g., where Release 17 of the 3GPP standards defines information for the configuration of the enhanced eDRX).

The UE may be configured with a non-enhanced eDRX cycle and/or an enhanced eDRX cycle for an RRC inactive mode. As an example, an enhanced eDRX cycle configuration (e.g., a Release 18 eDRX cycle configuration) may be configured with PTWs because of the longer durations of the eDRX cycles (e.g., greater than 10.24 seconds). For example, a UE may be configured with an eDRX cycle configuration having a duration less than or equal to 10.24 seconds (e.g., a Release 17 eDRX cycle configuration) associated with the RRC inactive mode. In some cases, the UE may additionally be configured with an enhanced eDRX cycle configuration (e.g., a Release 18 eDRX cycle configuration) having a duration greater than 10.24 seconds and/or including one or more PTWs associated with the RRC inactive mode.

In some cases, a UE may support the enhanced eDRX (e.g., for RRC inactive mode) only if the UE also supports eDRX for the RRC idle mode (e.g., a Release 17 RRC IDLE eDRX). In some examples, the UE may support the enhanced eDRX (e.g., for RRC inactive mode) only if the UE also supports eDRX for the RRC inactive mode (e.g., a Release 17 RRC_INACTIVE eDRX). A cell may support the enhanced eDRX (e.g., Release 18 enhanced eDRX). For example, a cell may indicate (e.g., via system information or other signaling) which DRX (or eDRX) types are supported by the cell. In some examples, a cell may allow (e.g., may support) the enhanced eDRX for RRC inactive mode (e.g., Release 18 enhanced eDRX) only if the cell supports eDRX for the RRC idle mode (e.g., an eDRX-Allowedidle parameter is configured). In some aspects, the cell may allow (e.g., may support) the enhanced eDRX for RRC inactive mode (e.g., Release 18 enhanced eDRX) only if the cell supports eDRX for the RRC inactive mode (e.g., Release 17 RRC-INACTIVE eDRX). A UE that is configured with the enhanced eDRX cycle configuration may apply (or use) the enhanced eDRX cycle configuration if the enhanced eDRX cycle configuration is supported by (e.g., is allowed in) a cell (e.g., a serving cell or a cell that the UE is camping on), regardless of whether the eDRX cycle configuration (e.g., non-enhanced or Release 17 eDRX) is supported by (e.g., is allowed in) the cell.

In some examples, a UE may fall back from applying an enhanced eDRX cycle configuration (e.g., a Release 18 or future release eDRX cycle configuration) to applying a non-enhanced eDRX cycle configuration (e.g., a Release 17 eDRX cycle configuration). For example, the UE may fall back from the enhanced eDRX cycle configuration to the non-enhanced eDRX cycle configuration for the RRC inactive mode (e.g., if capable of supporting, and configured with, the non-enhanced eDRX cycle configuration) if the enhanced eDRX cycle configuration is not allowed or supported by a current cell and the non-enhanced eDRX cycle configuration is allowed or supported by the current cell. For example, a network node may configure the UE with both the enhanced eDRX cycle configuration (e.g., a Release 18 or future release eDRX cycle configuration) and the non-enhanced eDRX cycle configuration (e.g., a Release 17 eDRX cycle configuration), thereby allowing the UE to select and/or fall back to the eDRX cycle configuration based on what a current cell supports or allows.

A UE may perform cell measurements and evaluate cell re-selection criteria during a single PTW. However, neighbor cell detections may occur across multiple PTWs. For example, a UE may collect one or more samples (e.g., measurements of a reference signal, such as an SSB) associated with the neighbor cell during a cell detection procedure. The UE may need to collect a certain quantity of samples to complete the cell detection procedure. When the UE re-selects to a new cell, the UE may receive a new list of neighbor cells to be monitored. One or more cells in the new list of neighbor cells may be in the process of detection when the UE performs the cell re-selection. For example, when camping on a first cell in the RRC inactive mode, the UE may initiate a cell detection procedure for a neighbor cell. Prior to completing the cell detection procedure, the UE may re-select to a new cell (e.g., a second cell). The UE may camp on the second cell in the RRC inactive mode. The neighbor cell may be included in the list of neighbor cells to be monitored when the UE is camping on the second cell.

However, the first cell and the second cell may be associated with different DRX cycle configurations and/or may support different types of DRX cycle configurations. For example, the first cell may support the enhanced eDRX cycle configuration and the second cell may not support eDRX. As another example, the first cell may support the enhanced eDRX cycle configuration and the second cell may only support the non-enhanced eDRX cycle configuration (e.g., may only support the Release 17 eDRX and not the Release 18 eDRX). As another example, the first cell and the second cell may both support the enhanced eDRX cycle configuration, but configuration parameters may be different for the first cell and the second cell (e.g., eDRX cycle durations may be different, PTW configuration may be different, or other configuration parameters may be different). As described elsewhere herein, an allowable (or expected) amount of time associated with performing a cell detection procedure (e.g., a delay condition for performing cell detection of neighbor cells) may be defined in terms of a DRX cycle. Therefore, when the UE re-selects to the second cell, the amount of time associated with the delay condition for performing cell detection of the neighbor cell (e.g., that is in the process of detection when the UE switches the selected cell from the first cell to the second cell) is unclear. The UE may not know how much time is expected to be associated with completing the cell detection procedure for the neighbor cell. As a result, the network (e.g., a network node) and the UE may not be synchronized as to the operations of the UE. As another example, the UE may consume resources (e.g., time resources, power resources, or other resources) performing the cell detection procedure over an inaccurate amount of time. As another example, the network may incorrectly assume that the UE has detected a neighbor cell after a given amount of time because the UE and the network are not synchronized as to the delay condition for cell detection of the neighbor cell.

Various aspects and techniques described herein relate to a cell re-selection transition period for cell detection. In some aspects, a time period (e.g., a cell re-selection transition period) may be defined for completing cell detection of a neighbor cell when the cell detection is in progress when a cell re-selection occurs. For example, the cell re-selection transition period may be an amount of time from when the UE initiates the cell detection procedure for a neighbor cell while camping on a first cell until the UE completes the cell detection, measurement and cell-selection criteria evaluation for the neighbor cell which completes after the UE has performed cell-reselection from the first cell to the second cell.

The UE may apply or use the cell re-selection transition period when a cell detection procedure for a neighbor cell is in progress when the UE performs reselection from a first cell to a second cell (and is to be completed after switching the selected cell to the second cell) and when one or more DRX (or eDRX) conditions are met. The one or more DRX (or eDRX) conditions may include the first cell and the second cell having different DRX cycle configurations (e.g., different eDRX cycle configurations). In some aspects, the one or more DRX (or eDRX) conditions may include one cell (from the first cell and the second cell) supporting an enhanced eDRX cycle configuration and the other cell (from the first cell and the second cell) not supporting the enhanced eDRX cycle configuration. In some aspects, the one or more DRX (or eDRX) conditions may include the first cell and the second cell having different configuration parameters for the enhanced eDRX cycle configuration.

In some aspects, an amount of time associated with the cell re-selection transition period may be defined based on, or otherwise associated with, a DRX cycle configuration of the first cell and/or a DRX cycle configuration of the second cell. In some aspects, the amount of time associated with the cell re-selection transition period may be defined based on, or otherwise associated with, an amount of time for which the UE has performed the cell detection procedure while camping on the first cell. For example, the amount of time associated with the cell re-selection transition period may be defined based on, or otherwise in association with, a first amount of time associated with performing one or more measurements of the neighbor cell while the selected cell is the first cell, and a second amount of time associated with restarting and performing the cell detection procedure in accordance with the second DRX cycle configuration of the second cell. As another example, the amount of time associated with the cell re-selection transition period may be defined based on, or otherwise associated with, a greater amount of time of a first amount of time associated with performing the cell detection procedure in accordance with the first DRX cycle configuration, or a second amount of time associated with performing the cell detection procedure in accordance with the second DRX cycle configuration. As another example, the amount of time associated with the cell re-selection transition period may be defined based on, or otherwise associated with, a first amount of time associated with performing one or more measurements of the neighbor cell while the selected cell is the first cell, and a second amount of time associated with performing a remaining one or more measurements associated with completing the cell detection procedure in accordance with the second DRX cycle configuration.

As a result, the UE may determine the amount of time to be associated with completing the cell detection procedure associated with the neighbor cell. Defining the cell re-selection transition period may enable the UE to complete cell detections of neighbor cells within an expected amount of time (e.g., expected by the network) when the UE re-selects to a new cell during the performance of the cell detection. This may improve network performance by ensuring that the UE performs the cell detection procedure within the expected amount of time and ensuring that the expected amount of time is synchronized between the UE and the network.

As indicated above, FIG. 5 is provided as an example. Other examples may differ from what is described with respect to FIG. 5.

FIG. 6 is a diagram of an example associated with operations 600 for cell re-selection transition periods for cell detection, in accordance with the present disclosure. As shown in FIG. 6, one or more network nodes 110 (for example, a base station, a CU, a DU, and/or an RU) may communicate with a UE 120. In some aspects, the network node 110 and the UE 120 may be part of a wireless network (for example, the wireless network 100). The UE 120 and the network node 110 may have established a wireless connection prior to operations shown in FIG. 6. In some aspects, the UE 120 may be a RedCap UE. As described in more detail elsewhere herein, the UE 120 may perform measurements of (e.g., may perform a cell detection procedure associated with) a neighbor cell 605. The neighbor cell 605 may be a network node 110 or may be supported by a network node 110 (e.g., the network node 110 depicted in FIG. 6 or another network node 110).

As shown by reference number 610, the UE 120 may transmit (directly or via one or more other network nodes), and the network node 110 may receive, a capability report. The UE 120 may transmit the capability report via UE capability signaling, a UE assistance information (UAI) communication, an RRC communication, a PUSCH, and/or a physical uplink control channel (PUCCH), among other examples. The capability report may indicate whether the UE 120 supports one or more operations described herein. In some aspects, the capability report may indicate whether the UE 120 supports one or more versions or types of DRX cycle configurations. For example, the capability report may indicate whether the UE 120 supports an eDRX cycle configuration for an RRC inactive mode. In some aspects, the capability report may indicate whether the UE 120 supports an enhanced eDRX cycle configuration (e.g., a Release 18 version of the eDRX cycle configuration for the RRC inactive mode) and/or another version (e.g., non-enhanced) of an eDRX cycle configuration (e.g., a Release 17 version of the eDRX cycle configuration for the RRC inactive mode).

In some aspects, the capability report may indicate whether the UE 120 supports a cell re-selection transition period for cell detection procedures, as described in more detail elsewhere herein. For example, the capability report may indicate whether the UE 120 supports determining or calculating an amount of time for a cell re-selection transition period for cell detection procedures (e.g., where the cell re-selection transition period defines an allowable amount of time for completing a cell detection procedure when a cell re-selection occurs during the cell detection procedure, as described elsewhere herein). In some aspects, the capability report may indicate one or more supported options for determining or calculating the amount of time to be associated with a given cell re-selection transition period. For example, the capability report may indicate that the UE 120 supports one or more different options or approaches for determining or calculating the amount of time to be associated with a given cell re-selection transition period. In some aspects, the capability report may indicate one or more supported sets of one or more parameters (e.g., options or approaches) associated with calculating a neighbor cell detection delay during the cell re-selection transition period.

The network node 110 may configure the UE 120 in accordance with the capability report. For example, the network node 110 may configure, or may trigger, the UE 120 to perform one or more operations based on, responsive to, or otherwise associated with the capability report indicating that the UE 120 supports the one or more operations. For example, the network node 110 may configure the UE 120 with one or more eDRX cycle configurations and/or one or more enhanced eDRX cycle configurations based on, responsive to, or otherwise associated with the capability report indicating that the UE 120 supports eDRX and/or enhanced eDRX (e.g., Release 18 eDRX). In some aspects, the network node 110 may configure the UE 120 with an option or approach for calculating a neighbor cell detection delay during the cell re-selection transition period based on, responsive to, or otherwise associated with the capability report indicating that the UE 120 supports the option or approach.

As shown by reference number 615, the network node 110 may transmit (directly or via one or more other network nodes), and the UE 120 may receive, configuration information. In some aspects, the UE 120 may receive the configuration information via one or more of system information signaling, RRC signaling, one or more MAC control elements (MAC-CEs), and/or DCI, among other examples. In some aspects, the configuration information may include an indication of one or more configuration parameters for selection by the UE 120, and/or explicit configuration information for the UE 120 to use to configure itself, among other examples.

The configuration information may indicate one or more DRX cycle configurations. For example, the configuration information may indicate one or more eDRX cycle configurations. The one or more DRX cycle configurations or eDRX cycle configurations may be associated with an RRC inactive mode. For example, the configuration information may indicate one or more DRX cycle configurations or eDRX cycle configurations to be applied by the UE 120 when the UE 120 is operating in the RRC inactive mode. In some aspects, the configuration information may indicate one or more enhanced eDRX cycle configurations (e.g., one or more Release 18 or future Release eDRX cycle configurations) and/or one or more eDRX cycle configurations (e.g., one or more Release 17 eDRX cycle configurations). The UE 120 may apply a given DRX cycle configuration, when operating in the RRC inactive mode, based on, or otherwise associated with, a capability of a cell that the UE has selected and/or is camping on. For example, if a current cell supports or allows an enhanced eDRX cycle configuration, then the UE 120 may apply an enhanced eDRX cycle configuration (e.g., associated with or configured for the current cell). If the current cell does not support or allow an enhanced eDRX cycle configuration, then the UE 120 may apply a non-enhanced (e.g., Release 17) eDRX cycle configuration (e.g., associated with or configured for the current cell). For example, when the UE 120 switches a selected cell from a first cell (e.g., that supports enhanced eDRX cycle configurations) to a second cell (e.g., that does not support enhanced eDRX cycle configurations), then the UE 120 may fall back from applying an enhanced eDRX cycle configuration to applying another DRX cycle configuration (e.g., a Release 17 eDRX cycle configuration). For example, the UE 120 may fall back from applying a Release 18 enhanced eDRX cycle configuration to applying a Release 17 eDRX cycle configuration when switching to a cell that does not support enhanced eDRX cycle configurations.

For example, the configuration information may indicate a first DRX cycle configuration associated with a first cell and a second DRX cycle configuration associated with a second cell. In some aspects, at least one of (or both) of the first DRX cycle configuration and the second DRX cycle configuration may be eDRX cycle configurations. The first DRX cycle configuration and the second DRX cycle configuration may be different. For example, the first DRX cycle configuration and the second DRX cycle configuration may be associated with a first set of one or more configuration parameters and the second DRX cycle may be associated with a second set of one or more configuration parameters. In some aspects, the first DRX cycle configuration and the second DRX cycle configuration may be different types of DRX cycle configurations (e.g., DRX and eDRX, or Release 18 eDRX and Release 17 eDRX). For example, the first DRX cycle configuration and the second DRX cycle configuration may be associated with different DRX cycle durations, different eDRX cycle durations, different versions of extended DRX cycle configurations (e.g., associated with different Releases), different support for PTWs (e.g., one DRX cycle configuration may configure PTWs and the other DRX cycle configuration may not configure PTWs), and/or different PTW configurations (e.g., different durations and/or periodicity for configured PTWs), among other examples. For example, the network node 110 may configure a Release 18 enhanced eDRX cycle configuration for one cell (e.g., from the first cell and the second cell) and a Release 17 eDRX cycle configuration for the other cell (e.g., from the first cell and the second cell).

In some aspects, the configuration information may indicate that the UE 120 is to calculate a neighbor cell detection delay associated with a cell re-selection transition period when the UE 120 switches between selected cells (e.g., in the RRC inactive mode). A selected cell may be a cell on which the UE 120 is currently camping. “Camping” on a cell or network node may refer to the UE 120 monitoring broadcasts from a cell (for example, monitoring a control channel associated with the cell or the network node) to maintain readiness to actively connect with the cell or network node and utilize the wireless network. For example, the UE 120 may “camp on” a cell of the wireless network and silently rely on periodic broadcasting of signals, such as system information blocks (SIBs) and/or SSBs, without a network node associated with the cell being aware of the camping UE. A UE that has selected a cell and that is monitoring the control channel (e.g., the PDCCH) of the cell is said to be “camped” on the cell.

In some aspects, the configuration information may indicate an option or approach (e.g., one or more parameters) indicating how the UE 120 is to calculate a neighbor cell detection delay associated with a cell re-selection transition period (e.g., an amount of time associated with the cell re-selection transition period). For example, the configuration(s) of the DRX cycles may indicate the option or approach to be used by the UE 120 to calculate the neighbor cell detection delay. In other aspects, another communication may indicate the option or approach to be used by the UE 120 to calculate the neighbor cell detection delay, such as an RRC communication, a MAC-CE communication, and/or a DCI communication. In some aspects, a first communication (e.g., an RRC communication or a MAC-CE communication) may indicate a set of allowable options, and a second communication may indicate (e.g., may down select) an option from the set of allowable options to be used by the UE 120. In other aspects, the option or approach to be used by the UE 120 may be defined, or otherwise fixed, by a wireless communication standard. In such examples, the option or approach may not be signaled from the network node 110 to the UE 120. For example, the UE 120 may be configured (e.g., via an original equipment manufacturer configuration) or stored via circuity of the UE to calculate the neighbor cell detection delay associated with a cell re-selection transition period in accordance with the option or approach that is defined, or otherwise fixed, by a wireless communication standard. The different options or approaches are described in more detail elsewhere herein.

The UE 120 may configure itself based at least in part on the configuration information. In some aspects, the UE 120 may be configured to perform one or more operations described herein based at least in part on the configuration information.

As shown by reference number 620, the UE 120 may select the first cell. For example, the UE 120 may select the first cell to camp on (e.g., while operating in the RRC inactive mode). A cell that is selected by the UE 120 for camping may be referred to herein as a “selected cell.” The UE 120 may select the first cell based on, or otherwise associated with, one or more measurements associated with the first cell. For example, the UE 120 may evaluate one or more cell selection criteria and may select the first cell based on, in response to, or otherwise associated with evaluating the one or more cell selection criteria (e.g., the first cell may be associated with a highest signal strength or quality among cells measured or monitored by the UE 120). The UE 120 may apply the DRX cycle configuration associated with the first cell. For example, the UE 120 may perform operations in accordance with the DRX cycle or eDRX cycle indicated by the DRX cycle configuration associated with the first cell.

As shown by reference number 625, the UE 120 may initiate a cell detection procedure associated with the neighbor cell 605 (e.g., while camping on the first cell and/or while a selected cell of the UE 120 is the first cell). “Initiating the cell detection procedure” may refer to the UE 120 performing a first measurement (e.g., first in time) of a reference signal (e.g., an SSB) associated with the neighbor cell 605 for cell detection. For example, the UE 120, while camping on the first cell, may perform the cell detection procedure in accordance with the DRX cycle configuration associated with the first cell. In other words, a timing of the measurement(s) of the neighbor cell 605 may be indicated by the DRX cycle configuration associated with the first cell. For example, as shown by reference number 630, the neighbor cell 605 may transmit, and the UE 120 may receive, one or more SSBs. The UE 120 may measure the one or more SSBs as part of the cell detection procedure associated with the neighbor cell 605. For example, the UE 120 may collect one or more cell detection samples (e.g., measurements of SSBs) associated with the neighbor cell 605 while camping on the first cell.

As shown by reference number 635, the UE 120 may select the second cell. For example, the UE 120 may select the second cell to be the selected cell. For example, the UE 120 may switch the selected cell from the first cell to the second cell. The second cell may be selected by the UE 120 as part of a cell re-selection procedure. The UE 120 may select the second cell to camp on (e.g., while operating in the RRC inactive mode). The UE 120 may switch, prior to a completion of the cell detection procedure associated with the neighbor cell 605, the selected cell from the first cell to the second cell.

For example, while the cell selection procedure is ongoing, the UE 120 may evaluate one or more cell selection criteria (e.g., associated with measurement(s) of the first cell and the second cell). The UE 120 may determine that the selected cell should be switched (e.g., should be re-selected) from the first cell to the second cell based on, in response to, or otherwise associated with evaluating the one or more cell selection criteria. The UE 120 may apply the second DRX cycle configuration associated with the second cell based on, in response to, or otherwise associated with switching from camping on the first cell to camping on the second cell (e.g., in the RRC inactive mode).

In some aspects, the UE 120 may detect one or more conditions that trigger the UE 120 to determine or calculate a neighbor cell detection delay for a cell re-selection transition period associated with the cell detection procedure of the neighbor cell 605. For example, the one or more conditions may include receiving a list of one or more neighbor cells to be monitored by the UE 120 associated with the second cell, where the neighbor cell is included in the list of one or more neighbor cells. For example, the list of one or more neighbor cells may include a configuration of one or more measurement objects corresponding to respective neighbor cells. The neighbor cell being included in the list of one or more neighbor cells to be monitored by the UE 120 may trigger the UE 120 to continue the ongoing cell detection procedure associated with the neighbor cell 605. Additionally, or alternatively, the one or more conditions may include the first cell and the second cell being associated with different DRX cycle configurations. For example, the one or more conditions may include the UE 120 being configured with a Release 18 enhanced eDRX cycle configuration for the first cell, but no eDRX for the second cell (or vice-versa). As another example, the one or more conditions may include the UE 120 being configured with a Release 18 enhanced eDRX cycle configuration for the first cell, but only a Release 17 eDRX cycle configuration for the second cell (or vice-versa). As another example, the one or more conditions may include the UE 120 being configured with Release 18 enhanced eDRX cycle configurations that are different for the first cell and the second cell (e.g., different PTW configurations, and/or different eDRX cycle lengths).

As shown by reference number 640, the UE 120 may complete the cell detection procedure in accordance with a cell re-selection transition period. For example, the UE 120 may calculate or determine an amount of time to be associated with a neighbor cell detection delay during the cell re-selection transition period. The UE 120 may calculate the amount of time based on, according to, or otherwise associated with an option, technique, approach, and/or parameter configured by the network node 110 and/or defined by a wireless communication standard, such as the 3GPP. The amount of time may be based on, or otherwise associated with, the first DRX cycle configuration (e.g., that is associated with the first cell) and/or the second DRX cycle configuration (e.g., that is associated with the second cell). In some aspects, the amount of time may be based on, or otherwise associated with, an amount of time for which the UE 120 has performed the cell detection procedure while camping on the first cell.

The cell re-selection transition period may define an allowable amount of time for completing the cell detection procedure. For example, the UE 120 may be expected to complete the cell re-selection transition period within a neighbor cell detection delay (e.g., that is calculated as described herein). In some aspects, the cell re-selection transition period may define an expected, an allowable, and/or a maximum amount of time for completing the cell detection procedure (e.g., associated with the neighbor cell 605). The cell re-selection transition period may begin at, or after, the initiation of the cell detection procedure. For example, the cell re-selection transition period (and/or the calculated neighbor cell detection delay) may start at the initiation of the cell detection procedure and may end at a completion of the cell detection procedure (e.g., after the UE 120 completes the cell detection, cell measurement, and/or cell-selection criteria evaluation for the neighbor cell 605).

For a first option (or calculation parameter), the UE 120 may calculate the amount of time associated with the cell re-selection transition period (and/or the calculated neighbor cell detection delay) based on, or otherwise associated with, an amount of time for which the UE 120 has performed the cell detection procedure while camping on the first cell and an amount of time associated with restarting and performing the cell detection procedure in accordance with the second DRX cycle configuration (e.g., associated with the second cell). For example, the UE 120 may drop (e.g., remove from memory) information associated with the cell detection procedure performed while the UE 120 was camping on the first cell. For example, the UE 120 may drop the samples (e.g., measurement samples) of the neighbor cell 605 collected as a part of the cell detection procedure performed while the UE 120 camped on the first cell. The UE 120 may restart the cell detection procedure for the neighbor cell 605 after the cell re-selection from the first cell to the second cell. The UE 120 may perform the cell selection procedure with delays corresponding to the cell detection requirements based on the DRX (or eDRX) cycle configuration of the second cell. The first option may be associated with decreased complexity because the UE 120 does not store information in memory from before the cell re-selection from the first cell to the second cell.

For a second option (or calculation parameter), the UE 120 may calculate the amount of time associated with the cell re-selection transition period (and/or the calculated neighbor cell detection delay) based on, or otherwise associated with, a greater amount of time of a first amount of time associated with performing the cell detection procedure in accordance with the first DRX cycle configuration, or a second amount of time associated with performing the cell detection procedure in accordance with the second DRX cycle configuration. In other words, the UE 120 may evaluate which DRX cycle configuration (from the DRX cycle configurations of the first cell and the second cell) is associated with less stringent delays (e.g., longer delays). The UE 120 may select the amount of time associated with the greater of the two calculated neighbor cell detection delays. For example, during the cell re-selection transition period, the UE 120 may meet the cell-detection delay condition that is the less stringent condition of the two conditions corresponding to the first cell and the second cell. After the cell re-selection transition period, the UE 120 may meet the delay condition corresponding to the second cell. For example, if the cell detection delay corresponding to the DRX/eDRX cycle configuration of the first cell is greater than the cell detection delay corresponding to the DRX/eDRX cycle configuration of the second cell (e.g., if the neighbor cell detection delay for the second cell is longer than the neighbor cell detection delay for the first cell), then the UE 120 may meet the cell detection delay requirements for the second cell. The second option may provide greater flexibility for the UE 120 to calculate the neighbor cell detection delay, while also reducing complexity by enabling the UE 120 to select the less stringent (or longer) neighbor cell detection delay.

For a third option (or calculation parameter), the UE 120 may calculate the amount of time associated with the cell re-selection transition period (and/or the calculated neighbor cell detection delay) based on, or otherwise associated with, an amount of time for which the UE 120 has performed the cell detection procedure while camping on the first cell and an amount of time associated with continuing (e.g., resuming) and completing the cell detection procedure in accordance with the second DRX cycle configuration (e.g., associated with the second cell). For example, the UE 120 may continue the cell detection procedure after the cell re-selection from the first cell to the second cell. The UE 120 may use measurement(s) (e.g., samples) collected while camping on the first cell and measurement(s) (e.g., samples) collected while camping on the second cell to complete the cell detection procedure. For example, during the cell re-selection transition period, the UE 120 may meet the cell detection delay conditions, which may be derived based on, or otherwise associated with, a quantity of samples collected in association with the DRX/eDRX cycle configuration of the first cell (e.g., a quantity of samples collected while camping on the first cell) plus a quantity of samples collected in association with the DRX/eDRX cycle configuration of the second cell (e.g., a quantity of samples collected while camping on the second cell). The DRX/eDRX cycle configurations of each cell may define or otherwise indicate the amount of time for collecting each quantity of samples (for the different cells). The third option may reduce an amount of time associated with performing the cell detection procedure, thereby reducing latency associated with detecting the neighbor cell 605.

In some aspects, the UE 120 may select an option or approach (e.g., the first option, the second option, or the third option described above) to calculate the neighbor cell detection delay. For example, the UE 120 may select the option based on, or otherwise associated with, a threshold. The UE 120 may receive a value of the threshold from the network node 110 (e.g., via system information signaling, RRC signaling, MAC-CE signaling, and/or DCI signaling). Additionally, or alternatively, a value of the threshold may be defined, or otherwise fixed, by a wireless communication standard, such as the 3GPP. The threshold may be defined in terms of a quantity of measurements performed by the UE 120 while camping on the first cell (e.g., before performing cell re-selection). For example, the threshold may be associated with a first quantity of measurements (or a quantity of measurement samples). The UE 120 may determine a second quantity of measurements (or a quantity of measurement samples) obtained by the UE 120 for the cell detection procedure while camping on the first cell (e.g., before performing cell re-selection). If the second quantity of measurements satisfies the threshold, then the UE 120 may select a given option (e.g., the third option described above). If the second quantity of measurements does not satisfy the threshold, then the UE 120 may select another option (e.g., the first option and/or the second option described above).

As another example, the threshold may be defined in terms of measurement quality. For example, the threshold may be associated with a measurement parameter, such as RSRP, RSRQ, signal-to-noise ratio (SNR), signal-to-interference-plus-noise ratio (SINR), and/or another measurement parameter. The UE 120 may determine one or more measurement values (e.g., in terms of the measurement parameter associated with the threshold) of measurements performed by the UE 120 while camping on the first cell (e.g., before performing cell re-selection). If the one or more measurement values satisfy the threshold (e.g., if at least one of the one or more measurement values satisfy the threshold, if a certain quantity or percentage of the one or more measurement values satisfy the threshold, or if all of the one or more measurement values satisfy the threshold), then the UE 120 may select a given option (e.g., the third option described above). If the one or more measurement values do not satisfy the threshold (e.g., if at least one of the one or more measurement values does not satisfy the threshold, if a certain quantity or percentage of the one or more measurement values do not satisfy the threshold, or if all of the one or more measurement values do not satisfy the threshold), then the UE 120 may select another option (e.g., the first option and/or the second option described above).

As shown by reference number 645, the neighbor cell 605 may transmit, and the UE 120 may receive and/or measure, one or more SSBs as part of the cell detection procedure. The UE 120 may measure the one or more SSBs (e.g., collect one or more measurement samples of the neighbor cell) in accordance with the calculated neighbor cell detection delay during the cell re-selection transition period. For example, the UE 120 may complete the cell detection procedure within the amount of time associated with the neighbor cell detection delay.

As indicated above, FIG. 6 is provided as an example. Other examples may differ from what is described with respect to FIG. 6.

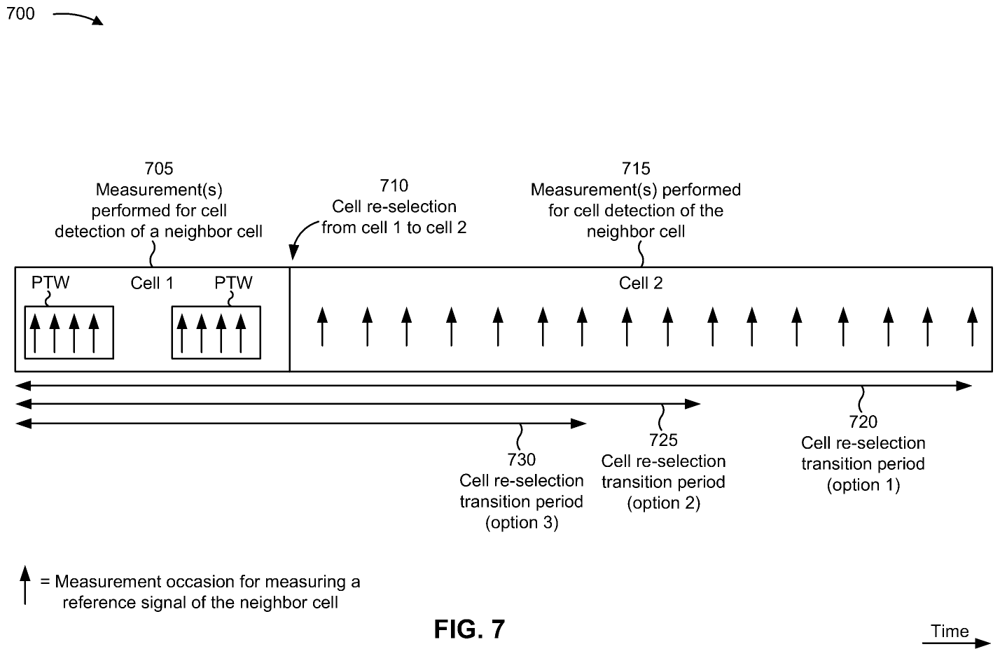

FIG. 7 is a diagram of an example 700 associated with cell re-selection transition periods for cell detection, in accordance with the present disclosure. As shown in FIG. 7, a UE 120 may perform a cell re-selection from a cell 1 to a cell 2 while a cell detection procedure of a neighbor cell is ongoing. The neighbor cell may be a cell that is to be monitored when the UE 120 is camping on the cell 1 or the cell 2 (e.g., the neighbor cell may be a cell to be monitored for UEs camping on either of the cell 1 and the cell 2).

The cell 1 and the cell 2 may be associated with different DRX cycle configurations. The example described in connection with FIG. 7 uses example values for parameters of the different DRX cycle configurations for ease of description. The techniques and aspects described herein may be similarly applied for other DRX cycle configuration parameters and/or other values. As an example, the cell 1 may be associated with an enhanced eDRX cycle configuration (e.g., a Release 18 enhanced eDRX cycle configuration). The enhanced eDRX cycle configuration may be associated with an eDRX cycle length of 20.48 seconds, a PTW length of 5.12 seconds, and a DRX cycle length of 1.28 seconds. Therefore, the UE 120 may be capable of performing 4 SSB measurements every 20.48 seconds because the UE may perform 4 SSB measurements during each PTW based on 4 DRX cycles being included in each PTW (e.g., 5.12 seconds divided by 1.28 seconds is equal to 4).

The cell 2 may be associated with an eDRX cycle configuration (e.g., a Release 17 eDRX cycle configuration without PTWs). For example, the eDRX cycle configuration may be associated with an eDRX cycle length of 10.24 seconds and a DRX cycle length of 2.56 seconds. Measurements performed by the UE 120, when applying the eDRX cycle configuration, may be performed according to the eDRX cycle length. For example, when applying the eDRX cycle configuration of the cell 2, the UE 120 may perform an SSB measurement every 10.24 seconds.

As shown by reference number 705, the UE 120 may perform one or more (but not all) of the measurements of a neighbor cell associated with the cell detection procedure while camping on the cell 1. For example, the UE 120 may perform one or more (but not all) of the measurements of the neighbor cell while applying the enhanced eDRX cycle configuration of the cell 1. For example, the cell detection procedure may be associated with the UE 120 performing 16 measurements (e.g., collecting 16 measurement samples) of the neighbor cell. As an example, and as shown by reference number 710, the UE 120 may perform a cell re-selection from the cell 1 to the cell 2.

For example, the cell re-selection may occur 40.96 seconds after the UE 120 initiated the cell detection procedure. As a result, the UE 120 may have collected only 8 of the 16 measurement samples for the cell detection procedure (e.g., when applying the enhanced eDRX cycle configuration of the cell 1, the UE 120 may be capable of measuring 4 SSBs every 20.48 seconds, as described above). Therefore, as described elsewhere herein, and as shown by reference number 715, the UE 120 may perform one or more measurements for the cell detection procedure while camping on the cell 2 (e.g., while applying the eDRX cycle configuration of the cell 2).

The UE 120 may calculate a neighbor cell detection delay associated with a cell re-selection transition period for the re-selection from the cell 1 to the cell 2. As a first example, the UE 120 may calculate that the neighbor cell detection delay associated with the cell re-selection transition period may be associated with a first amount of time 720. The first amount of time 720 may be calculated using the first option described above in connection with FIG. 6. For example, the first amount of time 720 may be based on, or otherwise associated with, an amount of time from the initiation of the cell detection procedure to the cell re-selection (e.g., 40.96 seconds in the example described above) plus an amount of time associated with completing the entire cell detection procedure in accordance with the DRX cycle configuration of the cell 2. For example, the UE 120 may drop the 8 measurement samples collected while camping on the cell 1 and collect all 16 measurement samples while camping on the cell 2. As a result, the first amount of time 720 may be 40.96+(16×10.24)=204.80 seconds because the amount of time associated completing the entire cell detection procedure in accordance with the DRX cycle configuration of the cell 2 may be (16×10.24), where one SSB measurement may be performed every 10.24 seconds.

As another example, the UE 120 may calculate that the neighbor cell detection delay associated with the cell re-selection transition period may be associated with a second amount of time 725. The second amount of time 725 may be calculated using the second option described above in connection with FIG. 6. For example, the second amount of time 725 may be associated with a greater amount of time among the cell detection delay in accordance with the DRX cycle configuration of the cell 1 and the cell detection delay in accordance with the DRX cycle configuration of the cell 2. For example, the cell detection delay in accordance with the DRX cycle configuration (e.g., the enhanced eDRX cycle configuration) of the cell 1 may be (16×(20.48/4)=81.92 seconds) because the cell detection procedure is associated with collecting 16 measurement samples and 4 measurement samples may be collected by the UE 120 every 20.48 seconds when applying the DRX cycle configuration (e.g., the enhanced eDRX cycle configuration) of the cell 1. The cell detection delay in accordance with the DRX cycle configuration of the cell 2 may be (16×10.24=163.84 seconds), where one SSB measurement may be performed every 10.24 seconds. Therefore, in this example, the second amount of time 725 may be 163.84 seconds, because 163.84 is greater than 81.92.

As another example, the UE 120 may calculate that the neighbor cell detection delay associated with the cell re-selection transition period may be associated with a third amount of time 730. The third amount of time 730 may be calculated using the third option described above in connection with FIG. 6. For example, the third amount of time may be based on, or otherwise associated with, an amount of time from the initiation of the cell detection procedure to the cell re-selection (e.g., 40.96 seconds in the example described above) plus an amount of time associated with performing the remaining measurements to complete the cell detection procedure in accordance with the DRX cycle configuration of the cell 2. For example, 8 measurements may remain for the cell detection procedure when the UE 120 performs cell re-selection from the cell 1 to the cell 2, as described above. Therefore, the third amount of time 730 may be (40.96+(8×10.24)=122.88 seconds).

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with cell re-selection transition periods for cell detection.

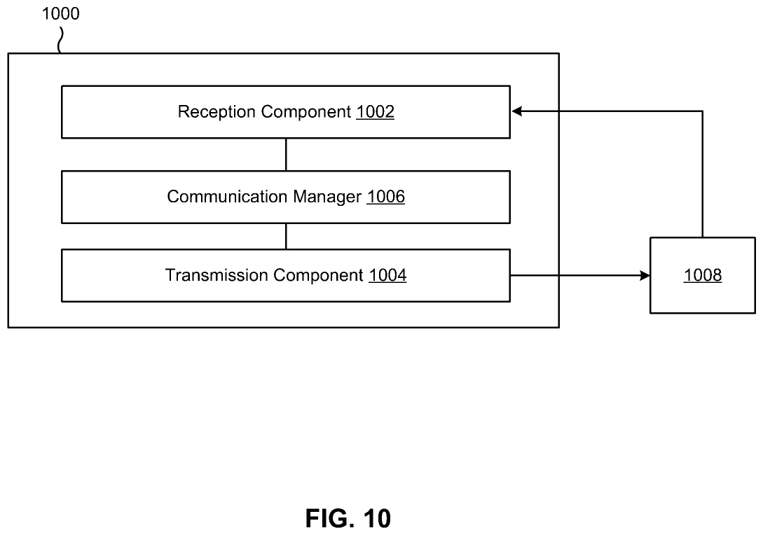

As shown in FIG. 8, in some aspects, process 800 may include receiving, from a network node, configuration information indicating a first DRX cycle configuration associated with a first cell and a second DRX cycle configuration associated with a second cell (block 810). For example, the UE (e.g., using reception component 1002 and/or communication manager 1006, depicted in FIG. 10) may receive, from a network node, configuration information indicating a first DRX cycle configuration associated with a first cell and a second DRX cycle configuration associated with a second cell, as described above.

As further shown in FIG. 8, in some aspects, process 800 may include initiating, while a selected cell of the UE is the first cell, a cell detection procedure associated with a neighbor cell (block 820). For example, the UE (e.g., using communication manager 1006, depicted in FIG. 10) may initiate, while a selected cell of the UE is the first cell, a cell detection procedure associated with a neighbor cell, as described above.

As further shown in FIG. 8, in some aspects, process 800 may include switching, prior to a completion of the cell detection procedure, the selected cell from the first cell to the second cell (block 830). For example, the UE (e.g., using communication manager 1006, depicted in FIG. 10) may switch, prior to a completion of the cell detection procedure, the selected cell from the first cell to the second cell, as described above.

As further shown in FIG. 8, in some aspects, process 800 may include performing, during a cell re-selection transition period, one or more measurements of the neighbor cell associated with the cell detection procedure, the cell re-selection transition period having an amount of time that is associated with at least one of the first DRX cycle configuration or the second DRX cycle configuration (block 840). For example, the UE (e.g., using communication manager 1006, depicted in FIG. 10) may perform, during a cell re-selection transition period, one or more measurements of the neighbor cell associated with the cell detection procedure, the cell re-selection transition period having an amount of time that is associated with at least one of the first DRX cycle configuration or the second DRX cycle configuration, as described above.

Process 800 may include additional aspects, such as any single aspect or any combination of aspects described below and/or in connection with one or more other processes described elsewhere herein.

In a first aspect, the cell re-selection transition period defines an allowable amount of time for completing the cell detection procedure.

In a second aspect, alone or in combination with the first aspect, initiating the cell detection procedure includes performing, while the selected cell is the first cell, a first measurement of a reference signal associated with the neighbor cell, and the cell re-selection transition period begins after the first measurement and ends at a completion of the cell detection procedure, while the selected cell is the second cell.

In a third aspect, alone or in combination with one or more of the first and second aspects, process 800 includes transmitting, to the network node, a capability report indicating at least one supported set of one or more parameters associated with calculating a neighbor cell detection delay during the cell re-selection transition period.

In a fourth aspect, alone or in combination with one or more of the first through third aspects, process 800 includes receiving, from the network node, an indication of one or more parameters associated with calculating a neighbor cell detection delay during the cell re-selection transition period, wherein the one or more parameters are selected from the at least one supported set of one or more parameters.

In a fifth aspect, alone or in combination with one or more of the first through fourth aspects, the indication of the one or more parameters is included in the configuration information.

In a sixth aspect, alone or in combination with one or more of the first through fifth aspects, the first DRX cycle configuration and the second DRX cycle configuration are eDRX cycle configurations.

In a seventh aspect, alone or in combination with one or more of the first through sixth aspects, the first DRX cycle is associated with a first set of one or more configuration parameters and the second DRX cycle is associated with a second set of one or more configuration parameters, and the first set of one or more configuration parameters is different than the second set of one or more configuration parameters.

In an eighth aspect, alone or in combination with one or more of the first through seventh aspects, the first DRX cycle configuration and the second DRX cycle configuration are associated with at least one of different DRX cycle durations, different extended DRX cycle durations, different versions of extended DRX cycle configurations, different support for PTWs, or different PTW configurations.

In a ninth aspect, alone or in combination with one or more of the first through eighth aspects, the amount of time is associated with a first amount of time associated with performing one or more measurements of the neighbor cell while the selected cell is the first cell, and a second amount of time associated with restarting and performing the cell detection procedure in accordance with the second DRX cycle configuration.

In a tenth aspect, alone or in combination with one or more of the first through ninth aspects, the amount of time is associated with a greater amount of time of a first amount of time associated with performing the cell detection procedure in accordance with the first DRX cycle configuration, or a second amount of time associated with performing the cell detection procedure in accordance with the second DRX cycle configuration.

In an eleventh aspect, alone or in combination with one or more of the first through tenth aspects, the amount of time is associated with a first amount of time associated with performing one or more measurements of the neighbor cell while the selected cell is the first cell, and a second amount of time associated with performing a remaining one or more measurements associated with completing the cell detection procedure in accordance with the second DRX cycle configuration.

In a twelfth aspect, alone or in combination with one or more of the first through eleventh aspects, the selected cell is a cell on which the UE is currently camping.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with cell re-selection transition periods for cell detection.

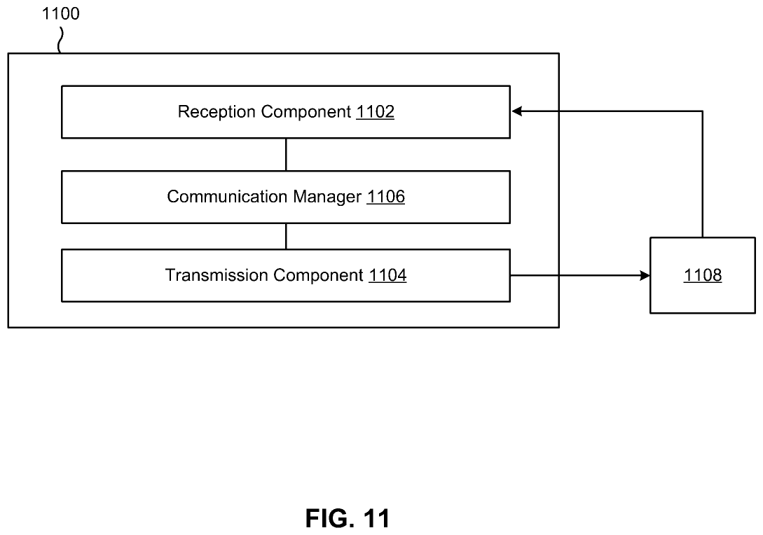

As shown in FIG. 9, in some aspects, process 900 may include receiving a capability report, associated with a UE, indicating one or more supported parameters for calculating an amount of time associated with a cell detection during a cell re-selection transition period (block 910). For example, the network node (e.g., using reception component 1102 and/or communication manager 1106, depicted in FIG. 11) may receive a capability report, associated with a UE, indicating one or more supported parameters for calculating an amount of time associated with a cell detection during a cell re-selection transition period, as described above.

As further shown in FIG. 9, in some aspects, process 900 may include transmitting an indication, for the UE, of one or more parameters for calculating the amount of time associated with the cell detection during the cell re-selection transition period in accordance with the capability report (block 920). For example, the network node (e.g., using transmission component 1104 and/or communication manager 1106, depicted in FIG. 11) may transmit an indication, for the UE, of one or more parameters for calculating the amount of time associated with the cell detection during the cell re-selection transition period in accordance with the capability report, as described above.

Process 900 may include additional aspects, such as any single aspect or any combination of aspects described below and/or in connection with one or more other processes described elsewhere herein.

In a first aspect, the one or more parameters are selected from the one or more supported parameters.

In a second aspect, alone or in combination with the first aspect, the indication of the one or more parameters is included in configuration information associated with configuring one or more DRX cycle configurations for respective cells.

In a third aspect, alone or in combination with one or more of the first and second aspects, the indication of the one or more parameters is communicated via at least one of a radio resource control communication, a MAC control element communication, or a downlink control information communication.

In a fourth aspect, alone or in combination with one or more of the first through third aspects, the one or more parameters include a parameter that indicates that the amount of time is associated with a first amount of time associated with performing one or more measurements of a neighbor cell while a selected cell is a first cell having a first DRX cycle configuration, and a second amount of time associated with restarting and performing a cell detection procedure of the neighbor cell, after switching the selected cell to a second cell, in accordance with a second DRX cycle configuration associated with the second cell, wherein the cell re-selection transition period is associated with completing the cell detection procedure after switching from the first cell to the second cell.

In a fifth aspect, alone or in combination with one or more of the first through fourth aspects, the one or more parameters include a parameter that indicates that the amount of time is associated with a greater amount of time of a first amount of time associated with performing a cell detection procedure of a neighbor cell in accordance with a first DRX cycle configuration associated with a first cell, or a second amount of time associated with performing the cell detection procedure in accordance with a second DRX cycle configuration associated with a second cell, wherein the cell re-selection transition period is associated with completing the cell detection procedure after switching from the first cell to the second cell.

In a sixth aspect, alone or in combination with one or more of the first through fifth aspects, the one or more parameters include a parameter that indicates that the amount of time is associated with a first amount of time associated with performing one or more measurements of a neighbor cell while a selected cell is a first cell, and a second amount of time associated with performing a remaining one or more measurements associated completing a cell detection procedure of the neighbor cell in accordance with a second DRX cycle configuration associated with a second cell, wherein the cell re-selection transition period is associated with completing the cell detection procedure after switching from the first cell to the second cell.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 6-7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, from a network node, configuration information indicating a first DRX cycle configuration associated with a first cell and a second DRX cycle configuration associated with a second cell. The communication manager 1006 may initiate, while a selected cell of the UE is the first cell, a cell detection procedure associated with a neighbor cell. The communication manager 1006 may switch, prior to a completion of the cell detection procedure, the selected cell from the first cell to the second cell. The communication manager 1006 may perform, during a cell re-selection transition period, one or more measurements of the neighbor cell associated with the cell detection procedure, the cell re-selection transition period having an amount of time that is associated with at least one of the first DRX cycle configuration or the second DRX cycle configuration.

The transmission component 1004 may transmit, to the network node, a capability report indicating at least one supported set of one or more parameters associated with calculating a neighbor cell detection delay during the cell re-selection transition period.

The reception component 1002 may receive, from the network node, an indication of one or more parameters associated with calculating a neighbor cell detection delay during the cell re-selection transition period, wherein the one or more parameters are selected from the at least one supported set of one or more parameters.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 6-7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a capability report, associated with a UE, indicating one or more supported parameters for calculating an amount of time associated with a cell detection during a cell re-selection transition period. The transmission component 1104 may transmit an indication, for the UE, of one or more parameters for calculating the amount of time associated with the cell detection during the cell re-selection transition period in accordance with the capability report.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving, from a network node, configuration information indicating a first discontinuous reception (DRX) cycle configuration associated with a first cell and a second DRX cycle configuration associated with a second cell; initiating, while a selected cell of the UE is the first cell, a cell detection procedure associated with a neighbor cell; switching, prior to a completion of the cell detection procedure, the selected cell from the first cell to the second cell; and performing, during a cell re-selection transition period, one or more measurements of the neighbor cell associated with the cell detection procedure, the cell re-selection transition period having an amount of time that is associated with at least one of the first DRX cycle configuration or the second DRX cycle configuration.

Aspect 2: The method of Aspect 1, wherein the cell re-selection transition period defines an allowable amount of time for completing the cell detection procedure.

Aspect 3: The method of any of Aspects 1-2, wherein initiating the cell detection procedure comprises: performing, while the selected cell is the first cell, a first measurement of a reference signal associated with the neighbor cell, and wherein the cell re-selection transition period begins after the first measurement and ends at a completion of the cell detection procedure, while the selected cell is the second cell.

Aspect 4: The method of any of Aspects 1-3, further comprising: transmitting, to the network node, a capability report indicating at least one supported set of one or more parameters associated with calculating a neighbor cell detection delay during the cell re-selection transition period.

Aspect 5: The method of Aspect 4, further comprising: receiving, from the network node, an indication of one or more parameters associated with calculating a neighbor cell detection delay during the cell re-selection transition period, wherein the one or more parameters are selected from the at least one supported set of one or more parameters.

Aspect 6: The method of Aspect 5, wherein the indication of the one or more parameters is included in the configuration information.

Aspect 7: The method of any of Aspects 1-6, where the first DRX cycle configuration and the second DRX cycle configuration are extended DRX (eDRX) cycle configurations.

Aspect 8: The method of any of Aspects 1-7, wherein the first DRX cycle is associated with a first set of one or more configuration parameters and the second DRX cycle is associated with a second set of one or more configuration parameters, and wherein the first set of one or more configuration parameters is different than the second set of one or more configuration parameters.

Aspect 9: The method of any of Aspects 1-8, wherein the first DRX cycle configuration and the second DRX cycle configuration are associated with at least one of: different DRX cycle durations, different extended DRX cycle durations, different versions of extended DRX cycle configurations, different support for paging time windows (PTWs), or different PTW configurations.

Aspect 10: The method of any of Aspects 1-9, wherein the amount of time is associated with: a first amount of time associated with performing one or more measurements of the neighbor cell while the selected cell is the first cell, and a second amount of time associated with restarting and performing the cell detection procedure in accordance with the second DRX cycle configuration.

Aspect 11: The method of any of Aspects 1-10, wherein the amount of time is associated with a greater amount of time of: a first amount of time associated with performing the cell detection procedure in accordance with the first DRX cycle configuration, or a second amount of time associated with performing the cell detection procedure in accordance with the second DRX cycle configuration.

Aspect 12: The method of any of Aspects 1-11, wherein the amount of time is associated with: a first amount of time associated with performing one or more measurements of the neighbor cell while the selected cell is the first cell, and a second amount of time associated with performing a remaining one or more measurements associated with completing the cell detection procedure in accordance with the second DRX cycle configuration.

Aspect 13: The method of any of Aspects 1-12, wherein the selected cell is a cell on which the UE is currently camping.

Aspect 14: A method of wireless communication performed by a network node, comprising: receiving a capability report, associated with a user equipment (UE), indicating one or more supported parameters for calculating an amount of time associated with a cell detection during a cell re-selection transition period; and transmitting an indication, for the UE, of one or more parameters for calculating the amount of time associated with the cell detection during the cell re-selection transition period in accordance with the capability report.

Aspect 15: The method of Aspect 14, wherein the one or more parameters are selected from the one or more supported parameters.

Aspect 16: The method of any of Aspects 14-15, wherein the indication of the one or more parameters is included in configuration information associated with configuring one or more DRX cycle configurations for respective cells.

Aspect 17: The method of any of Aspects 14-16, wherein the indication of the one or more parameters is communicated via at least one of a radio resource control communication, a medium access control (MAC) control element communication, or a downlink control information communication.

Aspect 18: The method of any of Aspects 14-17, wherein the one or more parameters include a parameter that indicates that the amount of time is associated with: a first amount of time associated with performing one or more measurements of a neighbor cell while a selected cell is a first cell having a first DRX cycle configuration, and a second amount of time associated with restarting and performing a cell detection procedure of the neighbor cell, after switching the selected cell to a second cell, in accordance with a second DRX cycle configuration associated with the second cell, wherein the cell re-selection transition period is associated with completing the cell detection procedure after switching from the first cell to the second cell.

Aspect 19: The method of any of Aspects 14-18, wherein the one or more parameters include a parameter that indicates that the amount of time is associated with a greater amount of time of: a first amount of time associated with performing a cell detection procedure of a neighbor cell in accordance with a first DRX cycle configuration associated with a first cell, or a second amount of time associated with performing the cell detection procedure in accordance with a second DRX cycle configuration associated with a second cell, wherein the cell re-selection transition period is associated with completing the cell detection procedure after switching from the first cell to the second cell.

Aspect 20: The method of any of Aspects 14-19, wherein the one or more parameters include a parameter that indicates that the amount of time is associated with: a first amount of time associated with performing one or more measurements of a neighbor cell while a selected cell is a first cell, and a second amount of time associated with performing a remaining one or more measurements associated completing a cell detection procedure of the neighbor cell in accordance with a second DRX cycle configuration associated with a second cell, wherein the cell re-selection transition period is associated with completing the cell detection procedure after switching from the first cell to the second cell.

Aspect 21: An apparatus for wireless communication at a device, comprising a processor; memory coupled with the processor; and instructions stored in the memory and executable by the processor to cause the apparatus to perform the method of one or more of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and/or measuring, among other examples. Also, “determining” can include receiving (such as receiving information), accessing (such as accessing data stored in memory), and/or transmitting (such as transmitting information), among other examples. Also, “determining” can include resolving, selecting, obtaining, choosing, establishing and other such similar actions.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated.

Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
one or more memories; and
one or more processors, coupled to the one or more memories, configured to cause the UE to:
receive, from a network node, configuration information indicating a first discontinuous reception (DRX) cycle configuration associated with a first cell and a second DRX cycle configuration associated with a second cell;
initiate, while a selected cell of the UE is the first cell, a cell detection procedure associated with a neighbor cell;
switch, prior to a completion of the cell detection procedure, the selected cell from the first cell to the second cell; and
perform, during a cell re-selection transition period, one or more measurements of the neighbor cell associated with the cell detection procedure, the cell re-selection transition period having an amount of time that is associated with at least one of the first DRX cycle configuration or the second DRX cycle configuration.

2. The UE of claim 1, wherein the cell re-selection transition period defines an allowable amount of time for completing the cell detection procedure.

3. The UE of claim 1, wherein the one or more processors, to initiate the cell detection procedure, are configured to cause the UE to:
perform, while the selected cell is the first cell, a first measurement of a reference signal associated with the neighbor cell, and
wherein the cell re-selection transition period begins after the first measurement and ends at a completion of the cell detection procedure, while the selected cell is the second cell.

4. The UE of claim 1, wherein the one or more processors are further configured to cause the UE to:
transmit, to the network node, a capability report indicating at least one supported set of one or more parameters associated with calculating a neighbor cell detection delay during the cell re-selection transition period.

5. The UE of claim 4, wherein the one or more processors are further configured to cause the UE to:
receive, from the network node, an indication of one or more parameters associated with calculating a neighbor cell detection delay during the cell re-selection transition period,
wherein the one or more parameters are selected from the at least one supported set of one or more parameters.

6. The UE of claim 5, wherein the indication of the one or more parameters is included in the configuration information.

7. The UE of claim 1, where the first DRX cycle configuration and the second DRX cycle configuration are extended DRX (eDRX) cycle configurations.

8. The UE of claim 1, wherein the first DRX cycle is associated with a first set of one or more configuration parameters and the second DRX cycle is associated with a second set of one or more configuration parameters, and
wherein the first set of one or more configuration parameters is different than the second set of one or more configuration parameters.

9. The UE of claim 1, wherein the first DRX cycle configuration and the second DRX cycle configuration are associated with at least one of:
different DRX cycle durations,
different extended DRX cycle durations,
different versions of extended DRX cycle configurations,
different support for paging time windows (PTWs), or
different PTW configurations.

10. The UE of claim 1, wherein the amount of time is associated with:
a first amount of time associated with performing one or more measurements of the neighbor cell while the selected cell is the first cell, and
a second amount of time associated with restarting and performing the cell detection procedure in accordance with the second DRX cycle configuration.

11. The UE of claim 1, wherein the amount of time is associated with a greater amount of time of:
a first amount of time associated with performing the cell detection procedure in accordance with the first DRX cycle configuration, or
a second amount of time associated with performing the cell detection procedure in accordance with the second DRX cycle configuration.

12. The UE of claim 1, wherein the amount of time is associated with:
a first amount of time associated with performing one or more measurements of the neighbor cell while the selected cell is the first cell, and
a second amount of time associated with performing a remaining one or more measurements associated with completing the cell detection procedure in accordance with the second DRX cycle configuration.

13. The UE of claim 1, wherein the selected cell is a cell on which the UE is currently camping.

14. A network node for wireless communication, comprising:
one or more memories; and
one or more processors, coupled to the one or more memories, configured to cause the network node to:
receive a capability report, associated with a user equipment (UE), indicating one or more supported parameters for calculating an amount of time associated with a cell detection during a cell re-selection transition period; and
transmit an indication, for the UE, of one or more parameters for calculating the amount of time associated with the cell detection during the cell re-selection transition period in accordance with the capability report.

15. The network node of claim 14, wherein the one or more parameters are selected from the one or more supported parameters.

16. The network node of claim 14, wherein the indication of the one or more parameters is included in configuration information associated with configuring one or more DRX cycle configurations for respective cells.

17. The network node of claim 14, wherein the indication of the one or more parameters is communicated via at least one of a radio resource control communication, a medium access control (MAC) control element communication, or a downlink control information communication.

18. A method of wireless communication performed by a user equipment (UE), comprising:
receiving, from a network node, configuration information indicating a first discontinuous reception (DRX) cycle configuration associated with a first cell and a second DRX cycle configuration associated with a second cell;
initiating, while a selected cell of the UE is the first cell, a cell detection procedure associated with a neighbor cell;
switching, prior to a completion of the cell detection procedure, the selected cell from the first cell to the second cell; and
performing, during a cell re-selection transition period, one or more measurements of the neighbor cell associated with the cell detection procedure, the cell re-selection transition period having an amount of time that is associated with at least one of the first DRX cycle configuration or the second DRX cycle configuration.

19. The method of claim 18, wherein the cell re-selection transition period defines an allowable amount of time for completing the cell detection procedure.

20. The method of claim 18, wherein initiating the cell detection procedure comprises:
performing, while the selected cell is the first cell, a first measurement of a reference signal associated with the neighbor cell, and
wherein the cell re-selection transition period begins after the first measurement and ends at a completion of the cell detection procedure, while the selected cell is the second cell.

21-30. (canceled)
